(19) United States
(12) Patent Application Publication
(10) Pub. No.: US 2005/0017548 A1
(43) Pub. Date: Jan. 27, 2005

(54) Motor vehicle which can be converted from a pick-up into a convertible

(75) Inventors: Thomas Rudolph, Hechendorf (DE); Michael Kolbl, Neuried (DE); Peter Oberhaus, Inning (DE); Francois De Gaillard, Paris (FR); Manfred Farber, Wielenbach (DE)

Correspondence Address: NIXON PEABODY, LLP, 401 9TH STREET, NW, SUITE 900, WASHINGTON, DC, 20004-2128, US

(73) Assignee: Webasto AG, Stockdorf (DE)

(21) Appl. No.: 10/866,184

(22) Filed: Jun. 14, 2004

(30) Foreign Application Priority Data
Jun. 12, 2003 (DE) 103 26 981.9

(51) Int. Cl. B60J 7/00

(52) U.S. Cl. 296/218; 296/107.17

(57) ABSTRACT

A motor vehicle is provided which includes a passenger compartment, a vehicle roof which in its closed position closes the passenger compartment, and a cargo bed open to the top and located behind the passenger compartment. The vehicle roof can be swiveled from its closed position into an open position in which its rear edge is located behind the passenger compartment near the cargo bed. A roof swiveling device is attached to the vehicle roof in the area of a rear edge of the roof for swiveling the vehicle roof out of the closed position into the open position. Thus the vehicle can be easily converted from a pick-up into a convertible.

### BACKGROUND OF THE INVENTION

1. Field of the Invention

The present invention relates to a motor vehicle with a passenger compartment, a vehicle roof which in its closed position closes the passenger compartment, and a cargo bed open on the top and located behind the passenger compartment.

2. Description of Related Art P Motor vehicles having a passenger compartment, a roof closing the passenger compartment and a cargo bed located behind the passenger compartment, often referred to as pick-ups, are becoming increasingly popular since they can be used in a versatile manner and are well suited especially for the transport of articles. On the other hand, convertibles are also becoming increasingly popular.

Published German patent application 100 28 780 A1 discloses a station wagon which can be converted into a pickup. To do this, the side windows, which are located behind a C pillar, and the back window are lowered, and the roof element covering these windows is pushed forward over or under the fixed roof which is located in front of this roof element. By moving the back window together with the frame which guides it forward and moving the back window up, the passenger compartment is closed to the rear, and the conversion of the station wagon into a pick-up is completed.

Published German patent application 100 28 777 A1 likewise discloses a station wagon which can be converted into a pick-up. To do this, the side windows, which are located behind the C pillar, and the back window are lowered. The roof element, covering these windows, is securely joined to two D pillars, the lower ends of which one end of a respective swiveling lever is coupled. The other end of this swiveling lever is coupled to the respective side wall. The roof element together with the two D pillars is swiveled forward and slightly up so that the roof element comes to rest over the fixed roof which is located in front of this roof element and the D pillars come to rest behind the C pillars. After the back window is moved up, the passenger compartment is closed again to the rear and the conversion of the station wagon into a pick-up is completed.

Neither of the two above-described station wagons, which can be converted into a pick-up, can be converted into a convertible. German Utility Model application 298 17 132 U1, however, discloses a pick-up with a sliding roof which is divided into two roof cover parts. The roof includes a roll bar located in the rear part of the passenger compartment as a fixed body part. The roof cover parts can be pushed to the rear on top of one another into a pocket in the transverse part of the roll bar. The roll bar must have a considerable length in the lengthwise direction of the vehicle for this purpose. In this way, the panoramic view which is desired in convertibles is adversely affected to a major degree. Moreover, the roof cannot be completely removed, but the roof length can be reduced at most to the length of the roof cover parts which lie on top of one another. Thus the vehicle cannot be regarded as a genuine convertible.

There do not appear to be any known vehicles in which conversion from a pick-up into a genuine convertible and vice versa can be accomplished. Thus the automobile buyer is forced to decide in favor of one of the two aforementioned vehicle types.

### SUMMARY OF THE INVENTION

The object of the present invention is to devise a pick-up which can be easily converted into a convertible and vice versa.

The above object, and other objects, are achieved by providing a vehicle roof that can be swiveled from its closed position into an open position in which its rear edge is located behind the passenger compartment near the cargo bed, and, in the area of its rear edge, is attached to a roof swiveling device for swiveling the vehicle roof out of the closed position into the open position. Thus the vehicle of the present invention can be easily converted from a pick-up into a convertible and vice versa. In this way, both the advantages of a pick-up and the advantages of a convertible can be combined and provided in a single vehicle.

One especially simple construction arises when the roof swiveling device is a C-shaped frame with an essentially horizontal leg and two legs which are essentially vertical in the closed position. The horizontal leg is attached in the rear edge of the motor vehicle roof, and the respective free end of the vertical legs is coupled to the back of the passenger compartment. Since the coupling of the horizontal leg takes place only on the rear edge of the motor vehicle roof, there need be only little space for the coupling.

The back window can preferably be lowered and, after moving the motor vehicle roof, can be raised again to assume the function of a wind deflector when being moved open.

The roof swiveling device can also be formed by at least part of the back window, which is coupled on its top edge to the rear edge of the motor vehicle roof and is coupled on its bottom edge to the back of the passenger compartment.

The motor vehicle roof can be stowed especially compactly when it is divided in the lengthwise direction of the motor vehicle into a front roof part and into a rear roof part and the front roof part can be moved over or under the rear roof part.

Preferably, the motor vehicle of the present invention has the functionality of a sliding roof in that the front roof parts can be fixed on its displacement path over or under the rear roof part in any position on the displacement path.

There may be one guide arrangement in each of the two lengthwise roof members for guiding at least the rear part of the motor vehicle roof thereby causing the motor vehicle roof to be guided especially well at least during the first part of its swiveling path.

### BRIEF DESCRIPTION OF THE DRAWINGS

FIG. 1 shows a perspective of a first embodiment of the motor vehicle of the present invention with the back window half-lowered;

FIG. 2 shows a view similar to FIG. 1 with the front roof part pushed to the rear;

FIG. 3 shows a view of a motor vehicle similar to FIG. 2 with a roof swiveling means made as a C-shaped frame shortly after starting its swiveling motion;

FIG. 4 shows a view similar to FIG. 3 with the motor vehicle roof which has been swiveled down and which can be swiveled toward the passenger compartment; and

FIG. 5 shows a view of a second embodiment of the motor vehicle of the present invention.

### DETAILED DESCRIPTION OF THE INVENTION

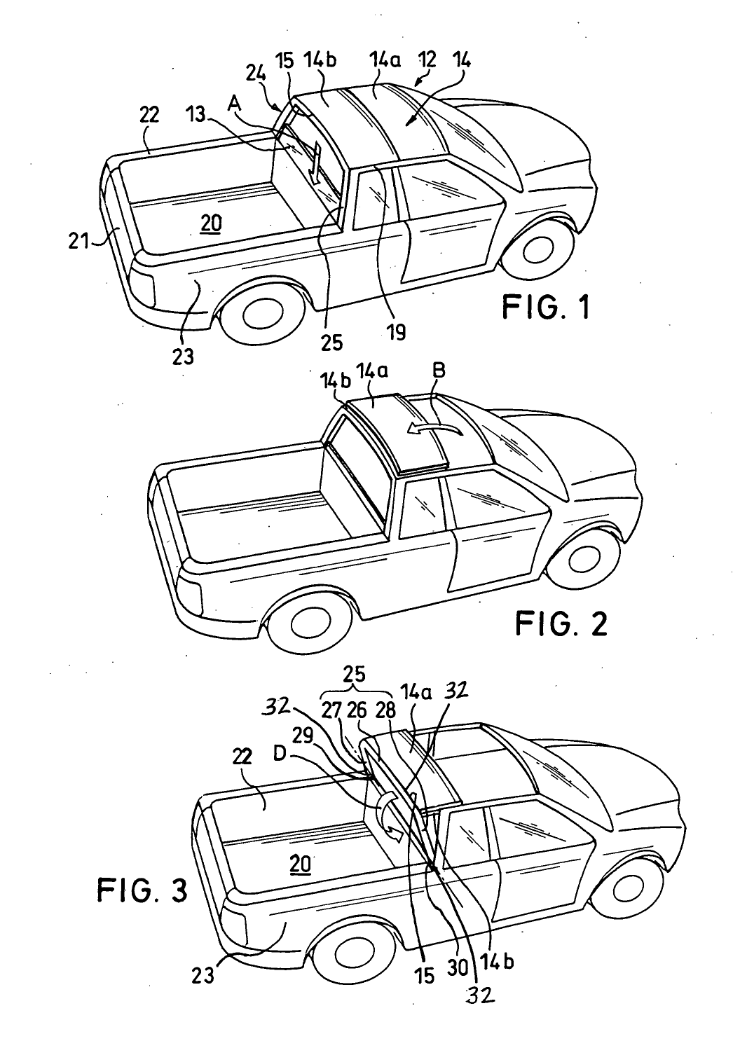

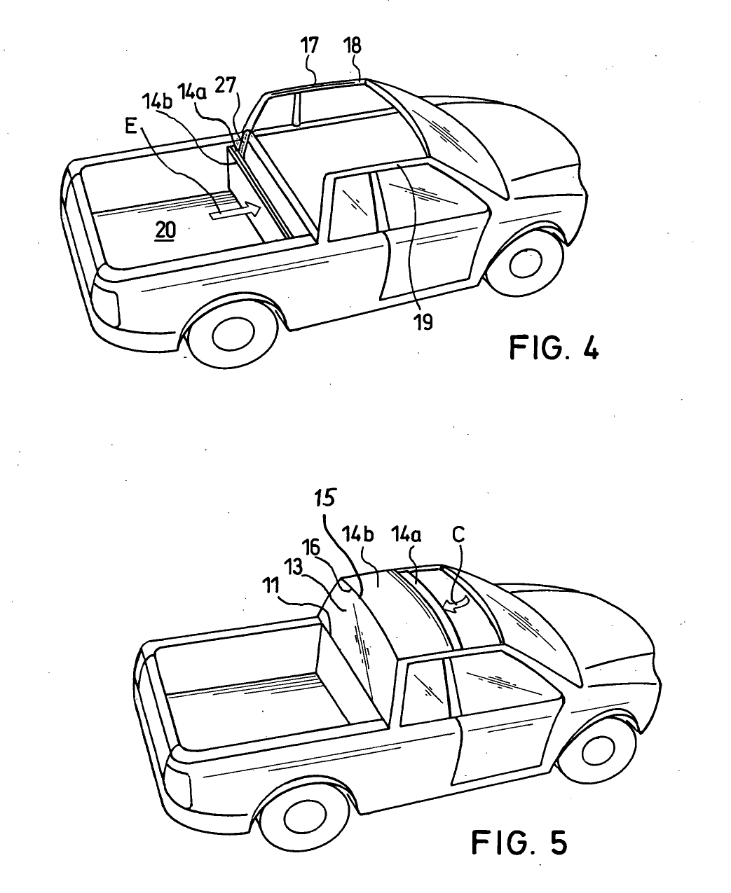

FIGS. 1-4 show a first embodiment of this invention. While FIG. 1 shows a vehicle made as a pick-up with a closed passenger compartment, FIG. 4 shows the same vehicle converted into a convertible (with the passenger compartment open to the top and to the rear). FIGS. 2 and 3 show intermediate positions during this conversion.

The motor vehicle of the present invention has a passenger compartment 12 which comprises a motor vehicle roof 14, a left lengthwise roof member 18 and a right lengthwise roof member 19. The motor vehicle roof 14 in this embodiment—relative to the lengthwise direction of the motor vehicle—is divided into a front roof part 14a and a rear roof part 14b. The passenger compartment 12 is closed on its back by a back window 13. A cargo bed 20 which adjoins the back of the passenger compartment 12 is bordered by a left side wall 22, a right side wall 23 and a tailgate 21. To swivel the motor vehicle roof 14, there is a roof swiveling device 24 with a structure and manner of operation which will be detailed later.

If at this point the pick-up is to be converted into a convertible, first the back window 13 is lowered as is indicated by the arrow A in FIG. 1. Afterwards, the front roof part 14a is raised and pushed to the rear over the rear roof part 14b. This movability of the front roof part 14a relative to the rear roof part 14b corresponds to the normal operation of an externally guided sliding roof and is independent of the convertibility of the pick-up into a convertible. Next, the roof package, which consists of the front roof part 14a and the rear roof part 14b, is swiveled down and to the rear. The situation shortly after the start of this swiveling process is shown in FIG. 3. The swiveling process is carried out by the roof swiveling device 24 which is formed, in this embodiment, as a C-shaped frame 25. This frame, on the one hand, comprises an essentially horizontally arranged leg 26 which is coupled to the rear or back edge 15 of the motor vehicle roof 14 (in this embodiment, to the back edge of the rear roof part 14b). FIG. 3 shows that the leg 26 is not completely straight and runs horizontal, but follows the roof curvature in the transverse direction of the motor vehicle. The frame 25 comprises the other two legs 27 and 28 which each extend from the ends of the leg 26 perpendicularly to it. Before the start of the swiveling process, or shortly afterwards, the legs 27, 28 are in the vertical position. The lower free ends 29 and 30 of the legs 27, 28 shown in FIG. 3 are coupled to the back of the passenger compartment 12. In the embodiment shown in FIG. 3, the coupling point is located roughly at the height of the top edge of the side walls 22, 23, therefore roughly in the middle between the top edge of the motor vehicle roof 14 and the cargo bed 20. The roof swiveling device 24 includes couplings, indicated generally at 32 (FIG. 3), between frame 25 and both the rear edge of the roof and the back of the passenger compartment 12 which permit sufficient swiveling of the components, such as one or more hinges.

After swiveling the frame 25 down, the roof package can be swiveled forward out of the roof parts 14a, 14b (arrow E in FIG. 4) until it adjoins the back of the passenger compartment 12 (roughly parallel to the lowered back window 13) and thus occupies very little cargo volume on the cargo bed 20. Of course this swiveling process can also be carried out during swiveling of the frame 25 down. The passenger compartment 12 is now open to the top and rear, i.e. the conversion of the pick-up into a convertible is completed. The back window 13 can then be moved again if necessary partially or completely up in order to be used as a wind deflector.

A guide rail 17 is provided in each of the lengthwise roof members 18, 19 to optimally guide the motor vehicle roof 14 during the initial phase of swiveling.

Alternatively to the above described conversion, it is also possible for the back window 13 to remain in its position moved up with the rear or back edge 15 of the motor vehicle roof 14 being slightly raised before it is swiveled down beyond the back window 13.

As is apparent from the description above, the transformation from a pick-up into a convertible (and vice versa) takes place without difficulty by pure translational movements and simple swiveling movements of the motor vehicle roof, i.e. no complicated sequences of movements of the motor vehicle roof are necessary. Of course, handling and comfort can be improved in the described transformation if this conversion takes place fully automatically, i.e. motor-driven. For the sake of clarity the motors required for this purpose are not shown in the drawings.

The roof part 14a can be stopped, and optionally fixed, in any of its intermediate positions between the initial position and the end position on its displacement path over the roof part 14b. Thus it is possible to implement the functionality of a sliding roof.

FIG. 5 shows a second embodiment of the present invention. To convert the pick-up into a convertible, first, the front roof part 14a is lowered and pushed to the rear under the rear roof part 14b. This movability of the front roof part 14a relative to the rear roof part 14b corresponds to normal operation of an internally guided sliding roof and is independent of the convertibility of the pick-up into a convertible. It can also be used in the first embodiment instead of the externally guided sliding roof. In this second embodiment, the top edge 16 of the back window 13 is connected via hinges to the back edge 15 of the motor vehicle roof 14 (or of the rear roof part 14b) and the lower edge 11 of the back window 13 is coupled to the back of the passenger compartment 12. The back window 13 here assumes the function of the frame 25. The swiveling process itself then takes place as in the first embodiment.

In another version, the roof swiveling device 24 can be made differently than in the first and the second embodiments, in the form of two arms which correspond roughly to the vertical legs 27, 28, without these two legs 27 and 28 being connected by a horizontal leg 26. The two arms are then coupled directly to the rear edge 15 of the motor vehicle roof 14.

In the description above, it was assumed that the motor vehicle roof 14 is divided into two roof parts 14a and 14b. When the functionality of a sliding roof is not desired or necessary, and the motor vehicle roof does not have an overly great length, the motor vehicle roof of course can also be in one piece. In this case, the front part of the motor vehicle roof 14, which comes to rest behind the back window 13 after swiveling to the rear and down, is preferably transparent in order not to interfere with an occupant's view to the rear through the back window 13.

1. A motor vehicle, comprising:
a passenger compartment;
a cargo bed located behind the passenger compartment;
a vehicle roof closing the passenger compartment when in a closed position, the vehicle roof being swivelable from its closed position into an open position in which a rear edge of the vehicle roof is located behind the passenger compartment near the cargo bed; and
a roof swiveling means attached to the vehicle roof in an area of the rear edge of the vehicle roof for swiveling the vehicle roof from the closed position into the open position.

2. The motor vehicle of claim 1, wherein the roof swiveling means is formed as a C-shaped frame with an essentially horizontal leg and two legs positioned essentially vertical in the closed position, the horizontal leg being attached to the rear edge of the motor vehicle roof, wherein a respective free end of each of the vertical legs are coupled to a back of the passenger compartment.

3. The motor vehicle of claim 1, wherein the passenger compartment includes a lowerable back window.

4. The motor vehicle of claim 1, wherein the passenger compartment includes a back window forming at least a part of the roof swiveling means, the back window including a top edge coupled to the rear edge of the motor vehicle roof and including a lower edge coupled to a back of the passenger compartment.

5. The motor vehicle of claim 1, wherein the vehicle roof is divided in the lengthwise direction of the vehicle into a front roof part and into a rear roof part, the front roof part being moveable over or under the rear roof part.

6. The motor vehicle of claim 5, wherein the front roof part can be stopped in any position along a displacement path over or under the rear roof part.

7. The motor vehicle of claim 1, wherein the passenger compartment includes a left lengthwise roof member and a right lengthwise roof member, each of the left and right roof members including one guide arrangement for guiding at least the rear roof part of the vehicle roof at least during the first part of its swiveling.

8. A motor vehicle, comprising:
a passenger compartment;
a cargo bed located behind the passenger compartment;
a vehicle roof closing the passenger compartment when in a closed position, the vehicle roof being swivelable from its closed position into an open position in which a rear edge of the vehicle roof is located behind the passenger compartment near the cargo bed; and
a roof swiveling device attached to the vehicle roof in the area of the rear edge of the vehicle roof for swiveling the vehicle roof from the closed position into the open position.

9. The motor vehicle of claim 8, wherein the roof swiveling device is formed as a C-shaped frame with an essentially horizontal leg and two legs positioned essentially vertical in the closed position, the horizontal leg being attached to the rear edge of the motor vehicle roof, wherein a respective free end of each of the vertical legs are coupled to a back of the passenger compartment.

10. The motor vehicle of claim 8, wherein the passenger compartment includes a lowerable back window.

11. The motor vehicle of claim 8, wherein the passenger compartment includes a back window forming at least a part of the roof swiveling device, the back window including a top edge coupled to the rear edge of the motor vehicle roof and including a lower edge coupled to a back of the passenger compartment.

12. The motor vehicle of claim 8, wherein the vehicle roof is divided in the lengthwise direction of the vehicle into a front roof part and into a rear roof part, the front roof part being moveable over or under the rear roof part.

13. The motor vehicle of claim 12, wherein the front roof part can be stopped in any position along a displacement path over or under the rear roof part.

14. The motor vehicle of claim 8, wherein the passenger compartment includes a left lengthwise roof member and a right lengthwise roof member, each of the left and right roof members including one guide arrangement for guiding at least the rear roof part of the vehicle roof at least during the first part of its swiveling.
